(19) United States
(12) Patent Application Publication
(10) Pub. No.: US 2002/0062403 A1
(43) Pub. Date: May 23, 2002

(54) Method and system for creation of virtual events

(76) Inventors: Jack T. Burnett, Austin, TX (US); John C. Oeffinger, Austin, TX (US)

Correspondence Address: Robert W. Holland, Baker Botts L. L. P., Suite 600, 2001 Ross Avenue, Dallas, TX, 75201-2980, US

(21) Appl. No.: 09/845,947

(22) Filed: Apr. 30, 2001

Related U.S. Application Data
(60) Provisional application No. 60/249,731, filed on Nov. 17, 2000.

(51) Int. Cl. G06F 9/46

(52) U.S. Cl. 709/318

(57) ABSTRACT

A distributed application service provider allows decentralized and dynamic creation of virtual events for presentation through the Internet in real time to meet specific presenter needs. An administration module authorizes plural organizations to create virtual events with a virtual event engine. An organization administrator authorizes event champions to create virtual events with a rapid event generator to generate a virtual event object that establishes the architecture of the virtual event. Based on permissions from the event champion, contributors, such as presenters keynote speakers, exhibitors and/or sponsors, upload content to the virtual event engine through a contributor module. Object oriented use cases define functionality for the virtual event engine to allow decentralized creation of virtual events that are created on demand in real time in a scalable and flexible manner, presented for a predetermined time, and archivable as objects tagged with metadata to establish an organization's larger learning architecture.

### RELATED APPLICATIONS

This application claims priority from U.S. Provisional application Ser. No. 60/249,731, entitled Virtual Teleconferencing, filed Nov. 17, 2000 and incorporated herein by reference.

### TECHNICAL FIELD

This invention relates generally to computer networks, and more specifically relates to a method and system for the creation, presentation and administration of virtual events over the Internet.

### BACKGROUND

Traditional instruction occurs in many contexts, including formal courses, conferences, symposia, workshops, single presentations and the like. The growing popularity of the Internet has introduced a significant new tool of online learning for distributing instruction material that substantially improves the distribution of learning courses and reduces inconvenience for students of traditional contexts that also take advantage of the Internet. For instance, online learning management systems (LMS) have garnered considerable attention as a convenient forum for extending traditional course topics through the Internet. LMS courses follow structures traditionally found in F2F courses, such as syllabus, lesson, topic and sub-topic structures. However, online courses are not typically applied to learning and instruction in the many contexts that fall outside of traditional F2F courses such as conferences, symposia, workshops, presentations and the like. These learning “events” typically have different structures than formal courses, whether F2F or online, with a variety of contributors presenting information in flexible programs generally loosely structured to appeal to diverse audiences.

One difficulty with the presentation of instructional material through the Internet is that the construction of a web site is a time consuming and labor intensive process. Further, a poorly constructed web site tends to disillusion users, leading to failure of the underlying goal in that users will not access information from a web site if the information is difficult to obtain. For instance, a web site for an online course might include reading material or video clips presented in a specific order. Such online course web sites are specifically designed to present information in a sequence that corresponds to the course. Although the individual design of a web site for a specific course provides a predictable and easy to follow sequence for users, the web sites are course-specific and not typically adaptable for other courses or other types of presentations. The expense of such specifically-designed web sites generally only makes financial sense if the course is presented to a large population over an extended period of time.

Another difficulty with learning management systems and online courses presented through the Internet is that the generation of such systems and courses is typically performed by a centralized design team that accepts material intended for the system or course and then formats the material for presentation on a web site. Centralized construction of a learning management system or online course is a time-consuming process which typically involves extensive communications between the web development team, the subject matter experts and other presenters of information. For instance, a development team accepts input from presenters and formats the web page for the review of the presenters. Edits and changes to the presentation material require written or oral communications that the development team translates into edits on the web site. Extensive changes take time to make and an inordinate rush inevitably results in a web site that is difficult for users to follow. Further, real time alterations to the web site are difficult to manage and track, typically resulting in further delay and confusion among users. This is especially true if students have started taking the course.

### SUMMARY

Therefore a need has arisen for a system and method which simplifies the creation and presentation of learning material through the Internet.

A further need has arisen for a system and method which presents learning material to Internet users with a user-friendly format.

A further need has arisen for a system and method which decentralizes creation of a web site for presentation of learning material to reduce the time required for getting the presentation material formatted for presentation.

In accordance with the teachings of the present disclosure, a system and method are provided that substantially eliminates or reduces disadvantages and problems associated with previously developed systems and methods for presenting learning material. A distributed application service provider allows decentralized and dynamic creation of virtual events for presentation through the Internet in real time to meet specific presenter needs.

More specifically, a virtual event engine provides a construction process, architecture, user experience and tools for organizations to easily create in real time an organization's own custom-branded virtual events. The virtual event engine applies application service provider (ASP) and web enabling databases, structures and methodologies as a framework for allowing presenters to define, design, develop, populate with content, test, deploy, archive and reconcile virtual events on demand. The ASP framework retains global control, development, support and system operation while decentralizing to presenters local control, event creation and deployment, and end-user relationship management.

An ASP administration module controls and maintains a framework within which presenter organizations create and present virtual events. The ASP administration module establishes financial parameters for presenter organizations to create plural virtual events through designated event champions in an automated fashion.

An organization administration module represents a decentralized point of contact for a presenter organization to authorize financial parameters for specific events. The organization administration module decentralizes virtual event approval from the administration module to individual organizations, thus reducing complexity for initiating a virtual event and allowing presenter organizations to budget and track expenditures.

An event champion module allows a manager appointed by the organization administration module to create one or more virtual events. A designated event champion, whether a member of the presenter organization or an independent contractor, manages a virtual event through a rapid event generator associated with the virtual event engine. The rapid event generator provides a graphical user interface that establishes a framework for the virtual event that allows contributors to populate the virtual event with content.

End user modules allow access to virtual events by authorized end users, such as attendees, contributors, presenters, sponsors, exhibitors, and members of the press. A contributor module allows contributors of material to the virtual event to upload that material for presentation. The event champion module authorizes contributions to an associated virtual event for approved contributors and has authority to approve or disapprove uploaded content. An attendee module provides an interface between attendees of the virtual event and the content of the virtual event. The attendee module monitors attendance to ensure approval and proper payment and identifies attendees according to their level of participation, such as exhibitor, contributor, press or regular attendee. An anonymous browser module provides public access to predetermined aspects of the virtual event so that individuals are able to determine whether the virtual event is one which they should attend. In order to register for the virtual event, the anonymous browser module requests member information from a member system module. The member system module tracks all attendees and contributors as members and provides keys to allow members to access virtual events.

The present invention provides a number of important technical advantages. One important technical advantage is that virtual events are created with templates that simplify the process of establishing content for presentation to attendees. The rapid events generator of the virtual event engine allows the event champion module to establish a standardized framework architecture to organize virtual event content. The organized structure of the framework allows contributors to upload a variety of information and allows attendees to access that information in an easy-to-follow format. Further, virtual events are easily incorporated into a collection of objects that are tagged with metadata, archived and searchable for retrieval and access as part of a larger learning architecture.

Another important technical advantage is that virtual events are constructed as a web site for presentation through the Internet so that presenters and attendees are able to interact in a user-friendly environment. Presenters who contribute content are able to do so through direct interaction with the virtual event. Preview of content is available to the presenter and the event champion for approval. The rapid event generator organizes and stores presentation material so that attendees are able to navigate content and communicate in a structured manner. Further, participation by contributors and attendees is easily tracked for billing and statistical purposes.

Another important technical advantage is that creation of a virtual event is distributed in a decentralized manner to an individual level to enable dynamic creation of virtual events on demand in real time in a scalable and flexible manner well adapted to meet the needs of organizations that frequently make presentations on short notice. Decentralization reduces the time and labor typically associated with the creation of a web site by allowing contributors to upload content directly. The dynamic nature of the rapid event generator allows organizations to leverage the Internet to rapidly disseminate learning material. Thus, virtual events substantially aid organization learning in a wide variety of applications, such as training members in the use of new systems and tools, distributing marketing materials, sales presentations, conferences, symposia, workshops and various presentations. By exercising local control through an event champion, an organization can present short virtual events with presentations or briefings on specific topics and related documents and electronic discussions or can present complex multi-week virtual conventions and trade shows with keynote addresses, speakers, exhibitors, sponsors, press attendants and participation from attendees around the world. Further, virtual events are easily organized and constructed to coincide with physical world events.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIG. 1 depicts a data context block diagram for a virtual event;

FIG. 2 depicts a graphical user interface of an organization administrator module to authorize creation of a virtual event;

FIG. 3 depicts a graphical user interface for a virtual event home page;

FIG. 4 depicts a graphical user interface for attending a virtual event program;

FIG. 5 depicts a graphical user interface for attending breakout sessions of a virtual event;

FIG. 6 depicts a block diagram for interfacing an ASP administration module with a virtual event database;

FIG. 7 depicts a block diagram for interfacing an organization administration module with a virtual event database;

FIG. 7A depicts a graphical user interface for creating an event instance through the organization administration module;

FIG. 8 depicts a block diagram for interfacing an event champion module with a virtual event database;

FIG. 8A depicts a graphical user interface for an event champion to manage associated events through the event champion module;

FIG. 8B depicts a graphical use interface of the rapid event generator;

FIG. 9 depicts a block diagram for interfacing a contributor module with a virtual event database;

FIG. 10 depicts a block diagram for interfacing an anonymous browser module with a virtual event database;

FIG. 11 depicts a block diagram for interfacing an attendee module with a virtual event database;

FIG. 12 depicts a block diagram for managing virtual event storage; and

FIG. 13 depicts a class diagram representing inheritance of objects of a virtual event.

### DETAILED DESCRIPTION

Preferred embodiments of the present invention are illustrated in the FIGURES, like numerals being used to refer to like and corresponding parts of the various drawings.

Virtual events provide a powerful learning tool that leverages the Internet to organize and present information in a short time for asynchronous presentation of learning material on demand to a desired audience. The present invention uses application service provider (ASP) and web enabling databases to populate and present virtual events for organizations. The distributed nature of the ASPs decentralizes creation of the virtual event to an individual contributor level for dynamic creation of the virtual event through the Internet for a predetermined time and incorporated into a collection of objects that are tagged with metadata so that the virtual events are archived and searchable for retrieval and access as part of an organization's larger learning architecture. Further, creation, presentation and attendance of virtual events are authorized and tracked so that organizations are able to monitor the cost and effectiveness of their virtual events.

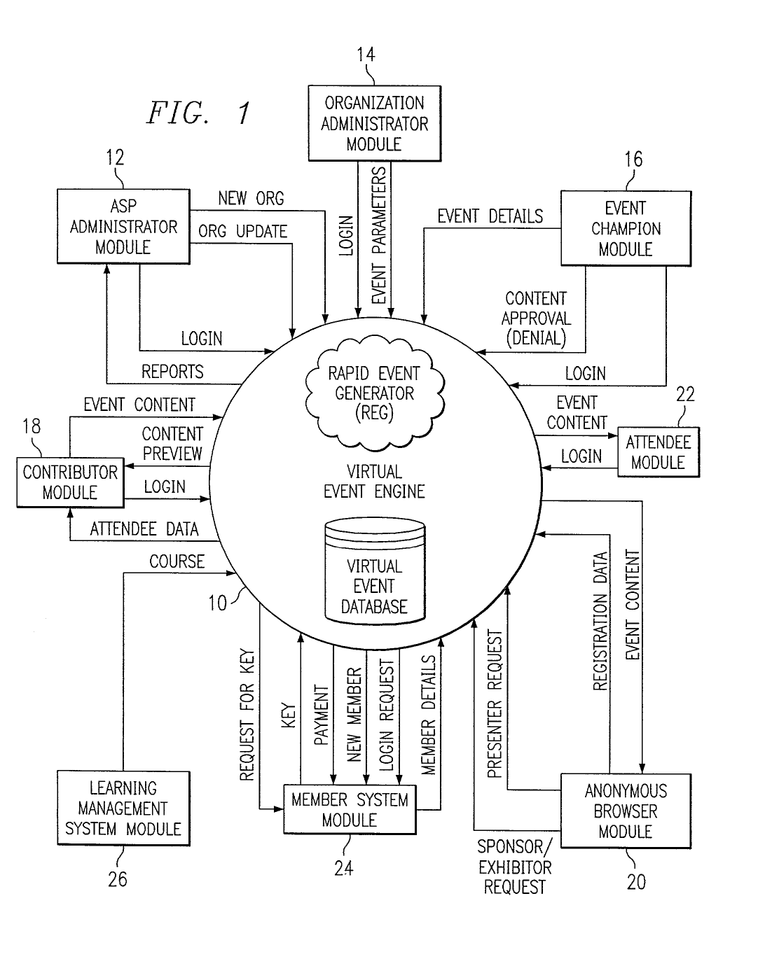

Referring now to FIG. 1, a block diagram depicts the data context of a virtual event. A virtual event engine 10 collects content and loads the content in a database for authorized contributors for each virtual event. The initial authorization to create a virtual event begins with ASP administration module 12 which authorizes an organization to access virtual event engine 10 through the Internet, manages the organization's use of virtual events, tracks and reviews organization virtual event details, and closes out and reconciles organization and individual virtual event accounts. ASP administration module 12 establishes financial constraints for an organization and secures the organization's agreement to comply with terms for use of the virtual event engine 10. ASP administration module 12 allows a central administrator to access information for each organization and each virtual event within virtual event engine 10 and establishes the application service provider templates used by contributors to upload content for virtual events. As depicted by FIG. 1, ASP administration module 12 provides a series of templates through a browser interface that allows a central administrator to log in for secure access, establish new organizations, update organization information, and download reports. For billing purposes, reports are output as web pages that are electronically transferable to organizations, such as by attachment to e-mails.

ASP administration module 12 provides each authorized organization access to virtual event engine 10 through an organization administration module 14. Organization administration module 14 decentralizes approval for individual virtual events so that a central authority at each organization is responsible for that organization's use of the system. Organization administration module 14 provides a unique login for the central authority of the organization and allows the central authority to establish virtual event parameters for one or more virtual events. Virtual event parameters authorize the creation of individual virtual events, provides the central organization administrator the ability to modify existing virtual events and further decentralizes the creation of virtual events by allowing the organization administrator to create and manage event champions responsible for each individual event. Organization administration module 14 displays to the organization administrator financial information, such as the number of virtual events currently authorized for the organization, enables paying attendees including the forms of payment, sponsors of the virtual event and their associated fees, and exhibitors of the virtual event and their associated fees. Organization administration module 14 also enables the branding, or consistent look and feel, to be set for the organization's events. In addition, organization administration module 14 displays links to allow the organization administrator to access existing virtual events.

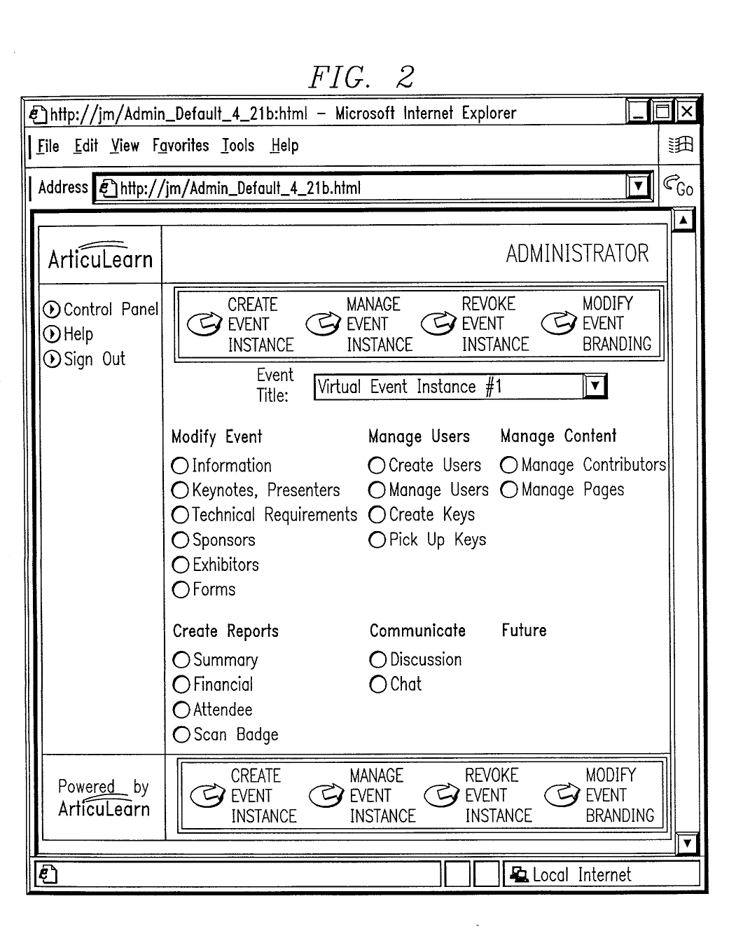

Referring now to FIG. 2, a graphical user interface 28 presented by organization administration module 14 is depicted. The organization administrator graphical user interface 28 provides authority for an organization administrator to authorize, or revoke event instances and identify an event champion to manage each event. For existing events, the administrator has authority to modify events and manage user access to the system including management of content loaded onto virtual event engine 10. In addition, the administrator has the ability to create reports that detail usage of the system by the organization, including costs and expenses. Graphical user interface 28 includes a communication navigation bar that supports direct electronic communication with event champion module 16.

Referring again to FIG. 1, event champions identified by organization administration module 14 are given authority to access virtual event engine 10 through event champion module 16. Event champion module 16 provides secure login to virtual event engine 10, allows an event champion to establish event details, and authorizes the event champion to approve or disapprove content loaded into the event champion's associated virtual event. The event champion module 16 displays a graphical user interface that allows the event champion to define the structure of the virtual event in cooperation with a rapid event generator 17 associated with virtual event engine 10. The virtual event definition includes an anticipated number of attendees, the identification of content contributors, and time constraints for the availability of the virtual event. Event champion module 16 also establishes the types of presentation content for the virtual event, such as different types of multi-media content and the types of attendees, such as access by the general public or a limited list of attendees, contribution file types for sponsors of the virtual event, and contribution file types for exhibitors of the virtual event. The rapid event generator 17 collects data and defines the virtual event structure through templates, and then stores the virtual event in a data base 11.

Once a virtual event is defined, event champion module 16 displays a manage virtual event graphical user interface that allows the event champion to control access to and content of a virtual event from its creation to its completion, including links to pricing and expense information, status of content, and content loaded by contributors, sponsors or exhibitors. Event champion module 16 also presents the event champion with a graphical user interface that allows the event champion to preview the virtual event to ensure the quality of content. For instance, once a contributor loads content for a virtual event, the content may only be changed by obtaining permission from the event champion.

Event champion module 16 authorizes predetermined contributors to access contributor module 18 to upload content for inclusion in a virtual event. Contributors, such as presenters, keynote speakers, exhibitors, and sponsors, are presented with identification and password request based on approval by the event champion to authorize access to the virtual event engine 10. Contributor module 18 provides a graphical user interface for contributor login and then allows the contributor to upload content for the virtual event based upon the contributor's roles and permissions as established by the event champion and authorized through rapid event generator 17. For instance, a keynote speaker is provided a field to insert a biography, an action button to insert a picture, an action button to upload a paper, and an action button to upload graphics, such as a video presentation. By comparison, an exhibitor purchases exhibit space in the virtual event and is given permission to upload content based upon the space purchased. Once a contributor uploads content, contributor module 18 enables a preview of that content as it will be displayed in the virtual event.

Once content upload is accomplished and the time for the virtual event is open, an anonymous browser module 20 allows outside users the ability to view selected areas of a virtual event and provides a registration form to allow the outside user to gain full access if authorized. Anonymous browser module 20 accepts registration data including registration requests related to special permissions from presenters, sponsors or exhibitors. Once a request for registration is received, a member system module 24 accepts the registration data and determines if the user is a member of the system. If not, a new membership is established. Once membership is established, member system module 24 accepts payment or a pre-approved key in lieu of payment. Keys, or electronic tokens, are arranged in advance to authorize predetermined users to access the virtual event without direct payment, such as may be requested from contributors. Once a payment or key is accepted, member system module 24 provides member details to virtual event engine 10 that enable interaction of the member with the desired virtual event.

An attendee module 22 provides a browser-based graphical user interface to support interaction of member attendees with the virtual event engine 10 when the members attend a virtual event. The member provides login information for the virtual event and then downloads event content by navigating with a browser through a web site associated with the virtual event. A learning management system 26 can supplement the virtual event with other course information such as a workshop.

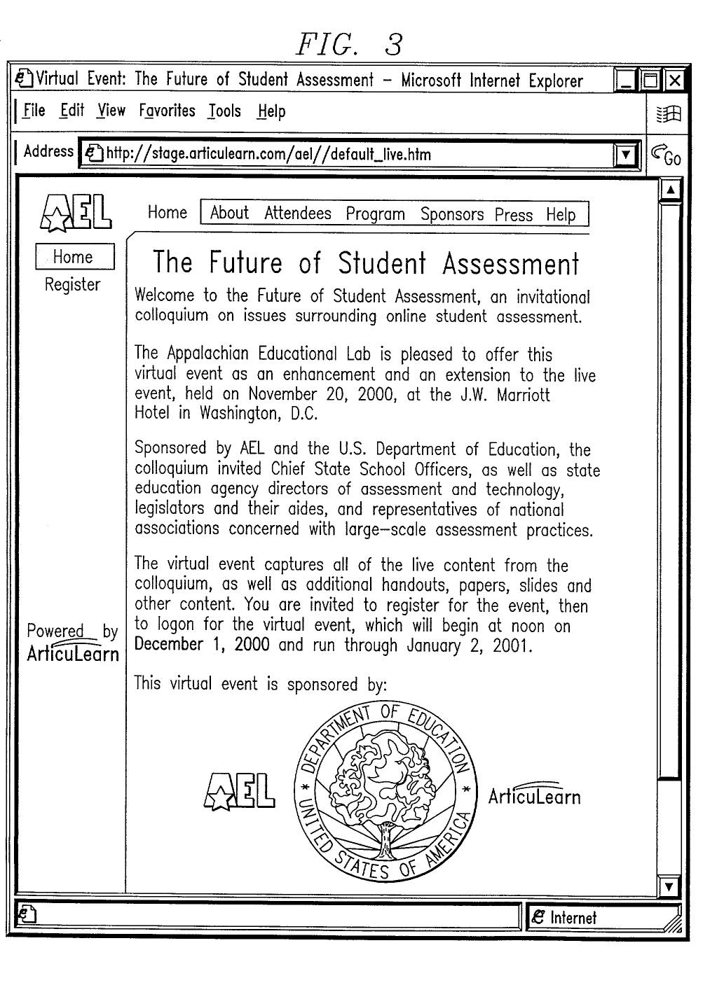

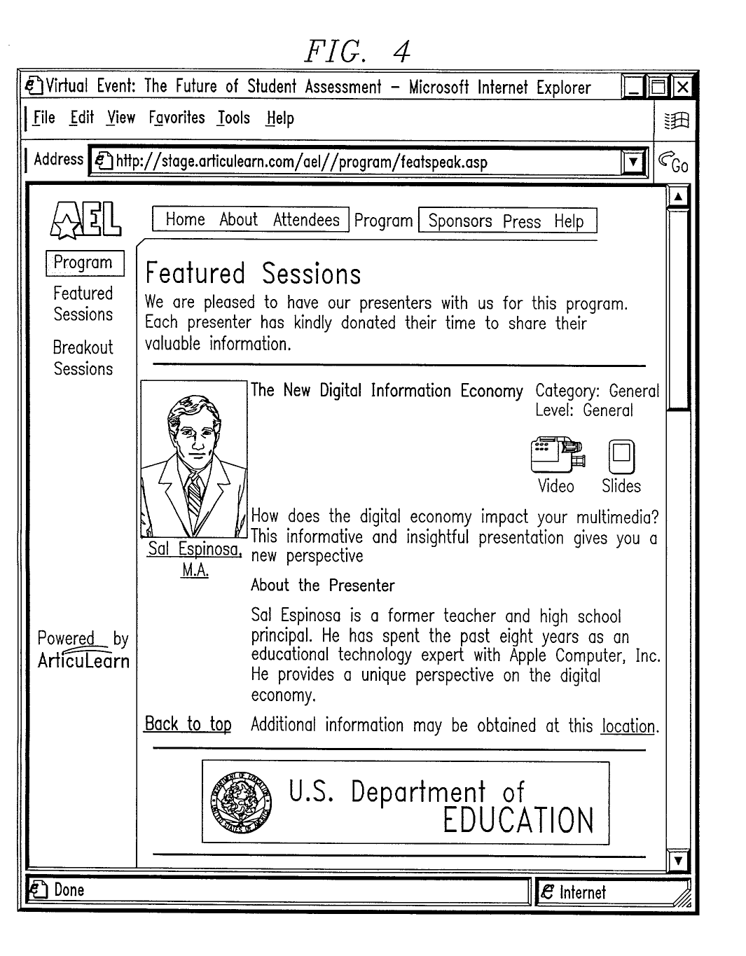

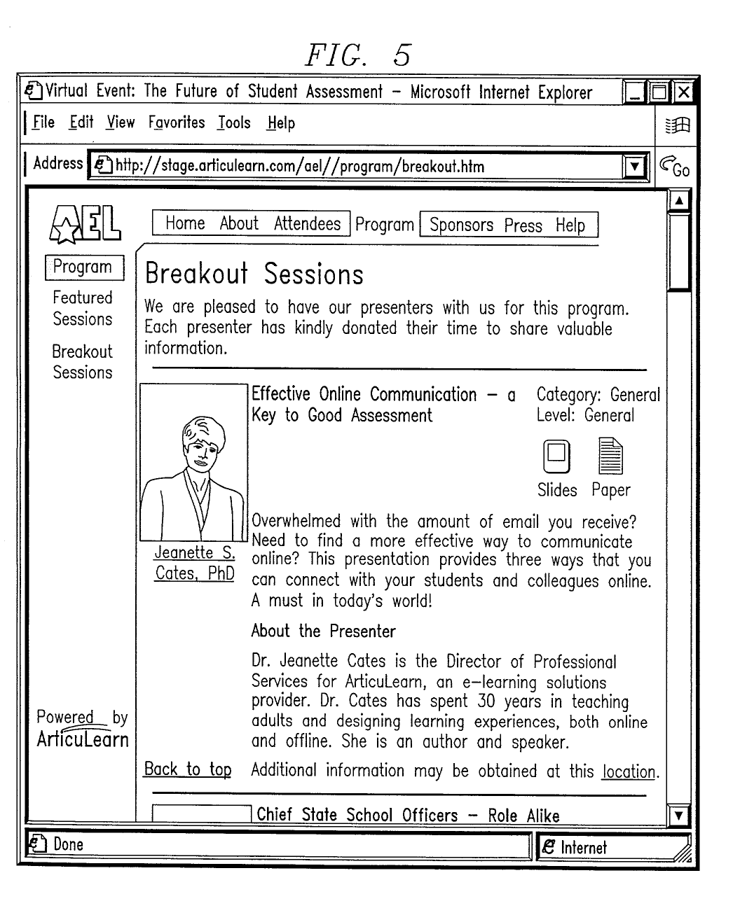

Referring now to FIG. 3, a graphical user interface presented by anonymous browser module 20 is depicted. An anonymous user has access to a home page that describes the general content of the virtual event and its sponsors. Anonymous browser module 20 allows the user to review the “about” page for additional information and then points the user to registration if the user desires additional access to the virtual event. Once a user registers, the user can access the virtual event program or, if the user is a member of the press, can access a press page. FIG. 4 depicts an example of a virtual event that includes a keynote speaker for a featured session of the virtual event. Links in the program page provide an attendee with access to a keynote presentation, including a video presentation and related slides. FIG. 5 depicts interactive breakout sessions available for attendees to participate in synchronous or asynchronous communication with other attendees relating to predetermined topics. In addition to interactive sessions, presentations associated with breakout sessions are available for attendees to review.

The present invention applies object-oriented techniques to establish a consistent data structure for the creation, presentation and archiving of virtual events. Virtual event engine 10 interacts with the interface module in a structure defined by object oriented use cases. By applying these use cases to generate browser-supported graphical user interfaces for display through the interface modules, data is stored in virtual event data base 11 so that virtual events are built in a decentralized manner.

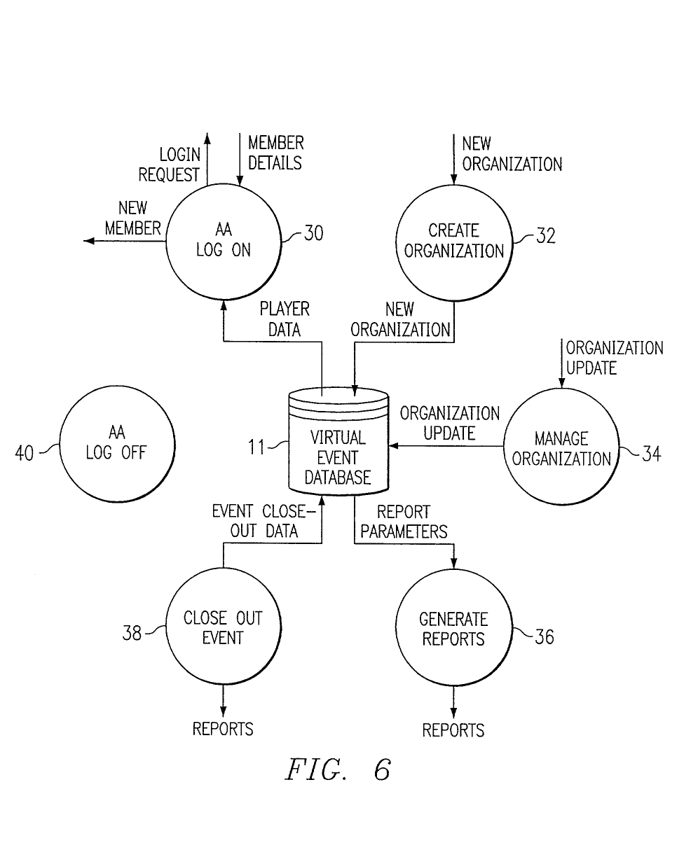

Referring to FIG. 6, a block diagram depicts use cases associated with ASP administration module 12 for interacting with virtual event database 11. Each use case represents object oriented programming structures that exchange objects with virtual event database 11 for interaction with virtual event engine 10. ASP administration log-on use case 30 provides an interface to accept log-in requests, authorize new members, authorize changes to member details, and to provide the ASP administrator with player data representing information on users of virtual event engine 10. Create organization use case 32 provides an ASP administrator with an interface to establish authorization for new organizations to access virtual event engine 10. Manage organization use case 34 provides an interface for the ASP administrator to update data on an existing organization. A generate reports use case 36 accepts data from virtual event database 11 and generates reports for usage and billing for organizations and virtual events, and provides those reports in an html or an exported report format for presentation to organizations. Closeout event use case 38 closes out events as they expire and arranges archiving of the events with reports to the ASP administrator. ASP administrator log-off use case 40 logs off an ASP administrator to ensure the integrity of the interface with virtual event engine 10.

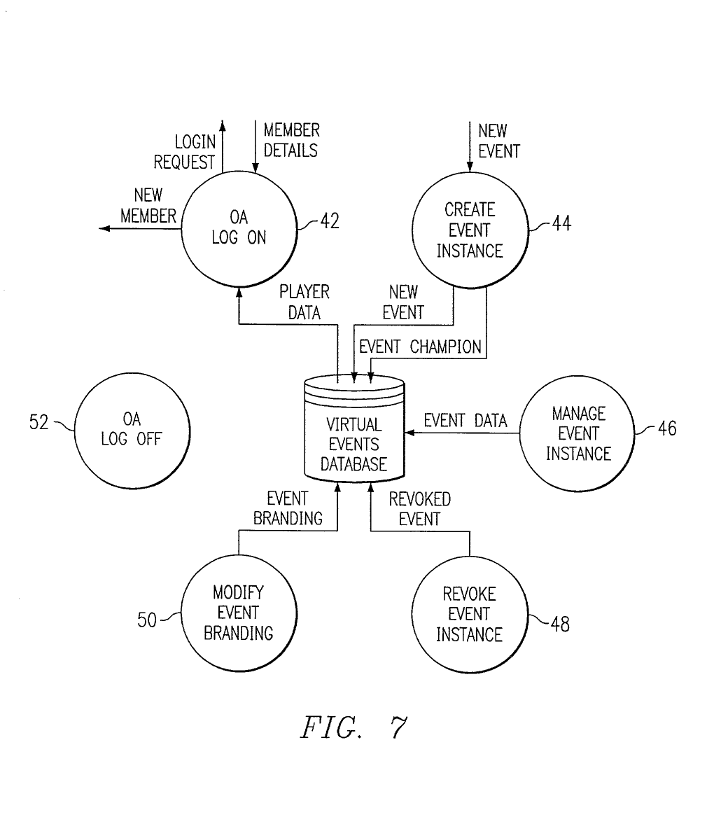

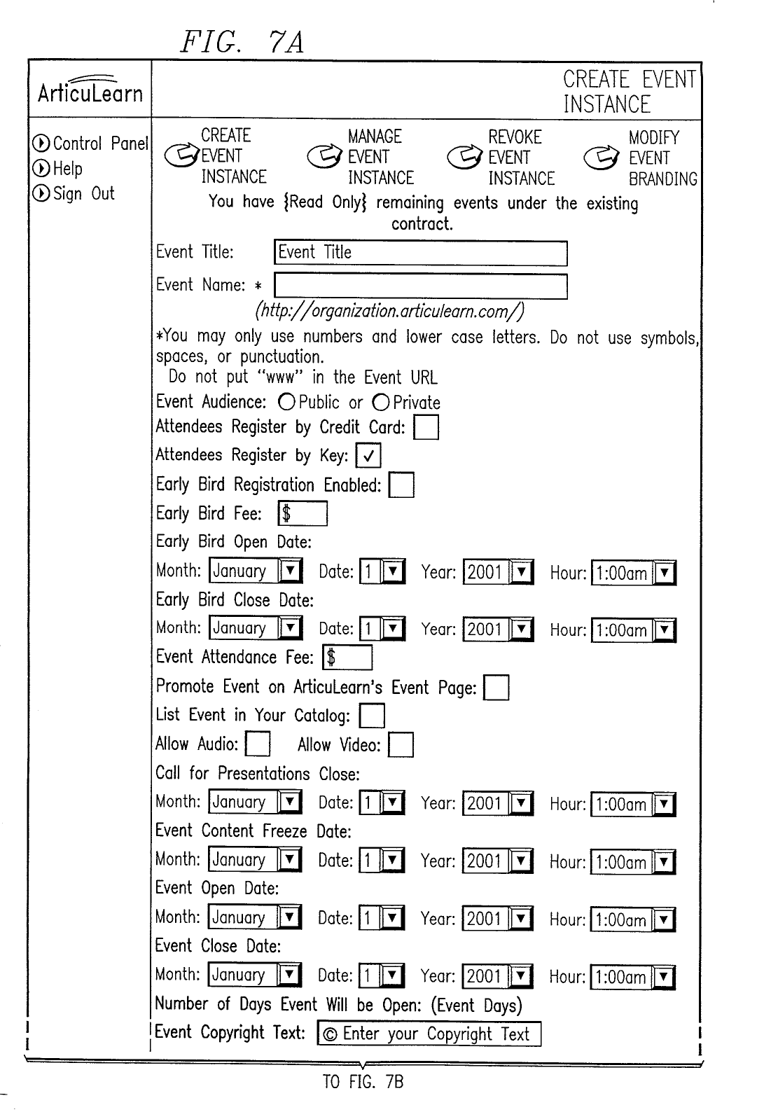

Referring now to FIG. 7, a block diagram depicts use cases associated with organization administration module 14 for interacting with virtual event database 11. Organization administrator log-on use case 42 allows the organization administrator to log-in once approved by the ASP administrator, to identify new members for access to the organizations data and virtual events, and to view details for members associated with the organization and its virtual events as well as for players active in a given virtual event. Create event instance use case 44 provides an interface for the organization administrator to authorize the creation of a new virtual event and to identify an event champion with authority to access and create the virtual events. In addition, create event instance use case 44 establishes the scope of the virtual event, including the attendees and payment for the virtual event, and a beginning and ending time for the virtual event. Virtual events having a duration of greater than a predetermined time, such as two weeks, are subject to approval by the organization administrator and/or the ASP administrator in order to avoid the presence of excessive numbers of virtual events active on the virtual event engine, which could result in slower performance as the database and band width are consumed. Manage event instance use case 46 provides the organization administrator with the ability to manage events created and otherwise managed by specific event champions. Revoke event instance use case 48 provides the organization administrator with an interface to revoke existing events, thus removing access to the event by the event champion. Modify event branding use case 50 provides the organization administrator with an interface to establish and modify branding information for virtual events associated with the organization. This branding capability allows an organization to have consistent market branding information associated with all of its virtual events. Organization administrator log-off use case 52 ensures system integrity by allowing an organization administrator to log-off of the virtual event engine. However, ASP administration module 12 provides the ASP administrator with the capability to perform all of the functions of the organization administrator for redundancy and security.

The graphical user interface depicted by FIG. 7A illustrates a browser-supported page for providing event information through create event instance use case 44. The organization administrator is provided with a set of selections, such as pull-down menus, that define information needed to authorize creation of a virtual event. Once input, this information is stored in the virtual event database as an event instance that in turn supports creation of a virtual event by an event champion. The organization administrator is informed of the number of events remaining and inputs information to define the new event, including a name, URL, audience and registration constraints, start and stop dates for registration, presentation input and virtual event days, and sponsor, exhibitor and workshop information. Once the information is input, the organization administrator simply clicks on the create button at the bottom of the graphical user interface to automatically create an event instance and store the event instance on the virtual event database.

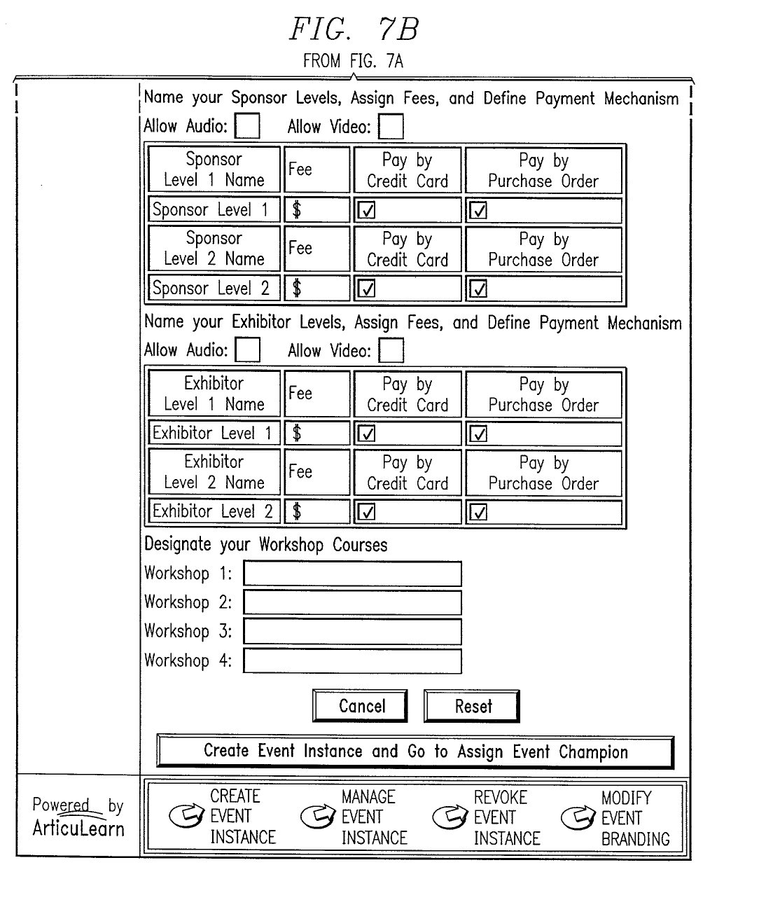

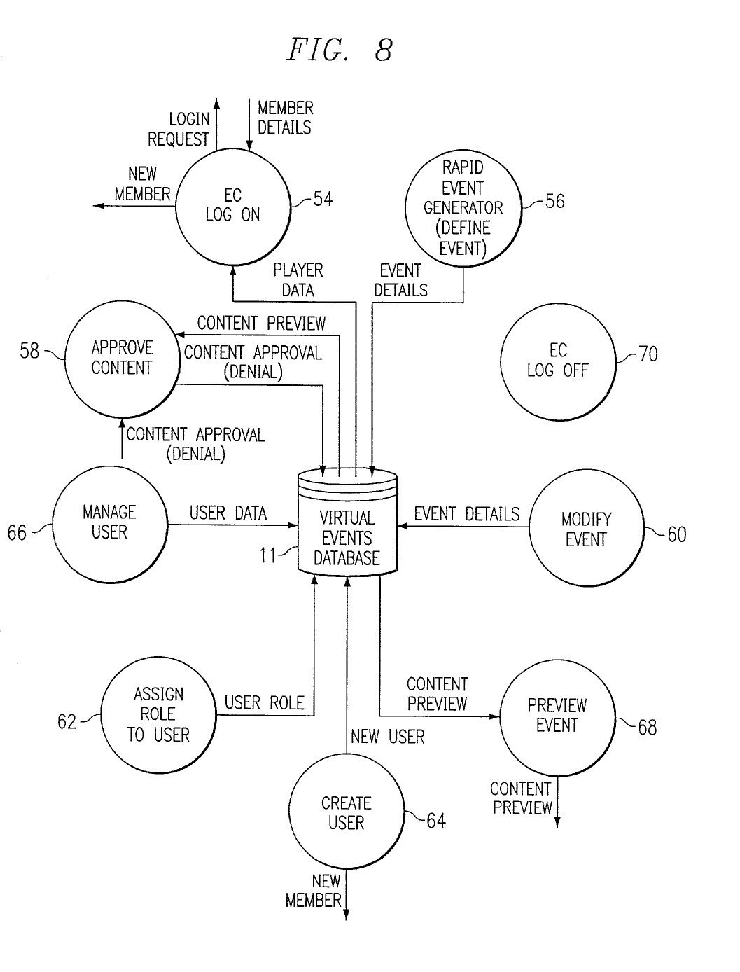

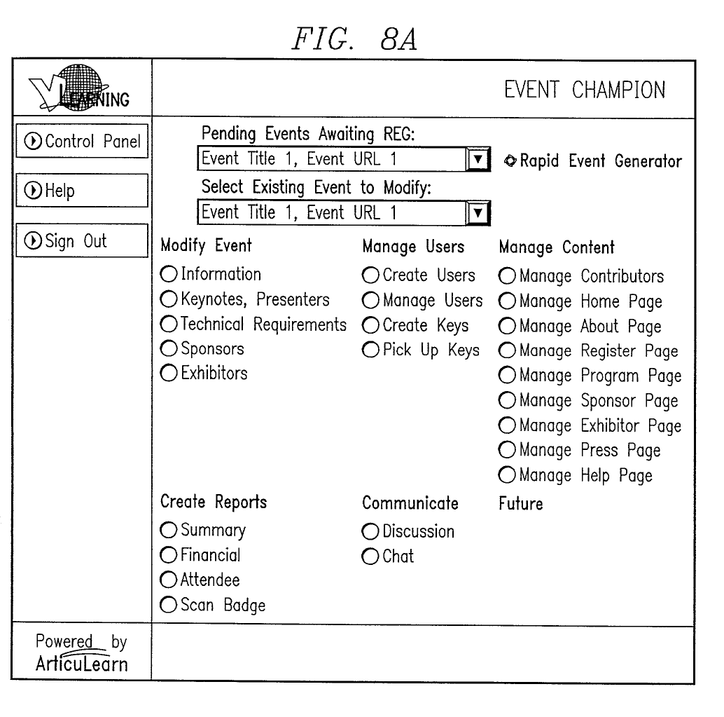

Referring now to FIG. 8, a block diagram depicts use cases associated with event champion module 16 for interacting with virtual event database 11. Event champion log-on use case 54 provides the event champion with access to virtual event engine 10, member details, player data, and access to establish new members for one or more predetermined virtual events associated with the event champion. The define event use case 56 provides the event champion with the rapid event generator functionality to define the structure of the virtual event. A series of pull-down menus allows the event champion to define the contributors to the virtual event and the type of contributions to be uploaded into virtual event database 11.

The event champion exercises control over the associated virtual event through a series of use cases that monitor and approve content loaded into virtual event database 11. An approve content use case 58 allows the event champion to preview content uploaded by contributors and then either approve or deny the content for inclusion in the virtual event. A modify event use case 60 allows the event champion to modify the structure of the virtual event, thus providing flexibility to alter the amount and type of content as well as the contributors and attendees from the time of the creation of the virtual event until its conclusion. An assign role use case 62 allows the event champion to assign particular roles to members, such as assigning the role of contributing a presentation, assigning the role of keynote speaker, and assigning the role of exhibitors, advertisers and the press. Create user use case 64 allows the event champion to define a new user for the virtual event and manage user use case 66 allows the event champion to manage the users created. As the virtual event is completed with the uploading of contributions, the event champion is able to preview the virtual event with preview event use case 68 to ensure that the virtual event experience of attendees will occur as planned. An event champion log-off use case 70 ensures secure log-off by the event champion to protect the integrity of the virtual event associated with the event champion. However, the organization administrator and the ASP administrator are able to perform all of the functions of the event champion at any time.

The graphical user interface depicted by FIG. 8A allows an event champion to manage one or more virtual events associated with the event manager. The event champion selects either a pending event yet to be generated by the rapid event generator or an existing event. For existing events, the graphical user interface communicates with the modify event use case 66 to allow the event champion to modify event parameters, to manage event users and to manage event content. In addition, the event champion creates reports for the selected event and communicates with the organization administrator and/or the ASP administrator. For pending events, the event champion selects the rapid event champion button to access the associated event instance and obtain access to a graphical user interface that allows input of data to define the virtual event parameters.

When the event champion selects the rapid event generator, the graphical user interface depicted by FIG. 8B is presented. The information presented in brackets ( {. . . }) is information set by the organization administrator which the event champion is not authorized to alter. The event champion provides information specific to the virtual event, such as its estimated attendance, information e-mail address, phone and fax, and a description of the event written by the event champion. The event champion also selects the pages to be included, such as the about, register, program, sponsor, exhibitor, press and help pages. Once the event champion selects the generate event button, the event is generated with a default set of pages. Selected pages become viewable by anonymous users.

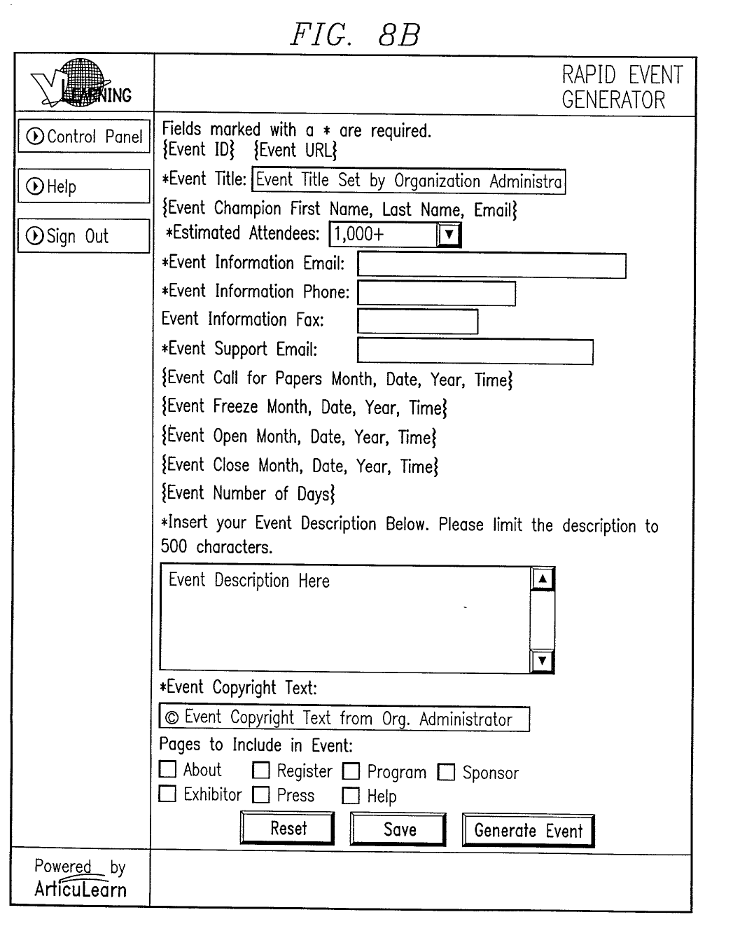

Referring now to FIG. 9, a block diagram depicts use cases associated with contributor module 18 for interacting with virtual event database 11. A contributor log-on use case 72 authorizes predetermined contributors access to virtual event database 11 for uploading the contributions approved by the event champion. Based on the definitions of the virtual event established by the event champion and the member information of the contributor, upload content use case 74 allows the contributor to upload predetermined types of content for inclusion in the virtual event. For instance, the event champion identifies a predetermined contributor as a keynote speaker and enables the keynote speaker to upload a video presentation and associated slide show. Once the contributor uploads the content, preview content use case 76 allows the contributor to view the content as it will be presented in the virtual event. A contributor log-off use case 78 logs the contributor off and prevents further access by the contributor to the uploaded content unless the contributor obtains approval from the event champion. By freezing uploaded content, contributor log-off use case 78 prevents changes to content entering the virtual event without the approval of the event champion.

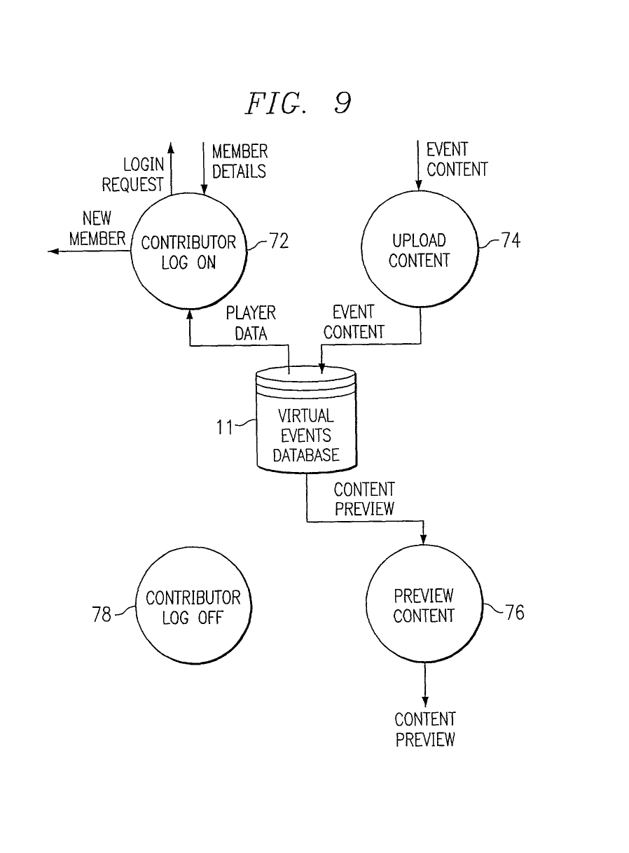

Referring now to FIG. 10, a block diagram depicts use cases associated with anonymous browser module 20 for interacting with virtual event database 11. View event pages use case 80 provides an anonymous browser with access to a limited number of predetermined event pages so that an anonymous user is able to obtain an understanding of the content of the virtual event. The event pages available to the general public are defined by the event champion. An anonymous browser is allowed to interact with virtual event database 11 in a number of specific instances. For instance, a register at event use case 82 presents the anonymous browser with the ability to register at the virtual event, including establishing a new membership and paying for the event. Once registered, the anonymous user becomes a member who has access as defined by an attendee. An anonymous browser may also request to contribute to the virtual event through a request presenter use case 84 or request sponsor or exhibitor use case 86. As an example, view event pages use case provides information to the public about the proposed content of the virtual event in advance of its start, and includes a request for contributors such as presenters, sponsors and exhibitors. Responses to the request for contributors are forwarded to the event champion for consideration and potential inclusion in the virtual event. A request for press pass use case 88 provides special access to the virtual event for members of the press to encourage public interest in the virtual event when desired.

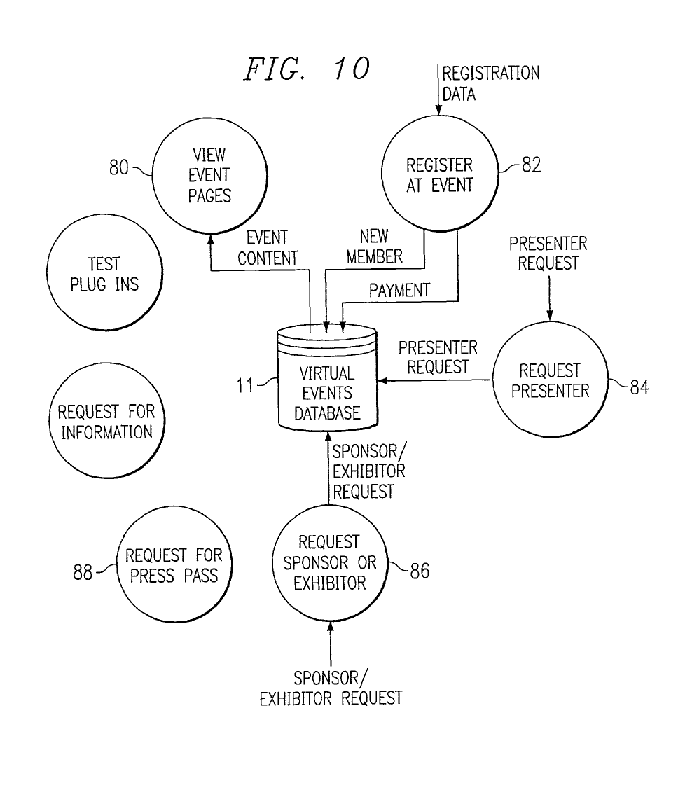

Referring now to FIG. 11, a block diagram depicts use cases associated with attendee module 22 for interacting with virtual event database 11. Attendee log-on use case 90 accepts log-in requests and confirms requests with member data. Attend event use case 92 provides a browser based interface for authorized attendees to view event content. Attend chat use case 94, attend discussion use case 96, and attend workshop use case 98, along with related use cases for performing functions to present virtual events content, each provide an interface for attendees to interact with virtual event content and other attendees. An attendee log-off use case 100 logs attendees off of the system to ensure security and to track use.

One significant advantage to object oriented architecture is that virtual events are achievable and retrievable as part of an organization's overall learning structure. By creating virtual events and storing data as objects having related instances, methods and attributes, the present invention provides a consistent architecture for construction and use of virtual events by organizations.

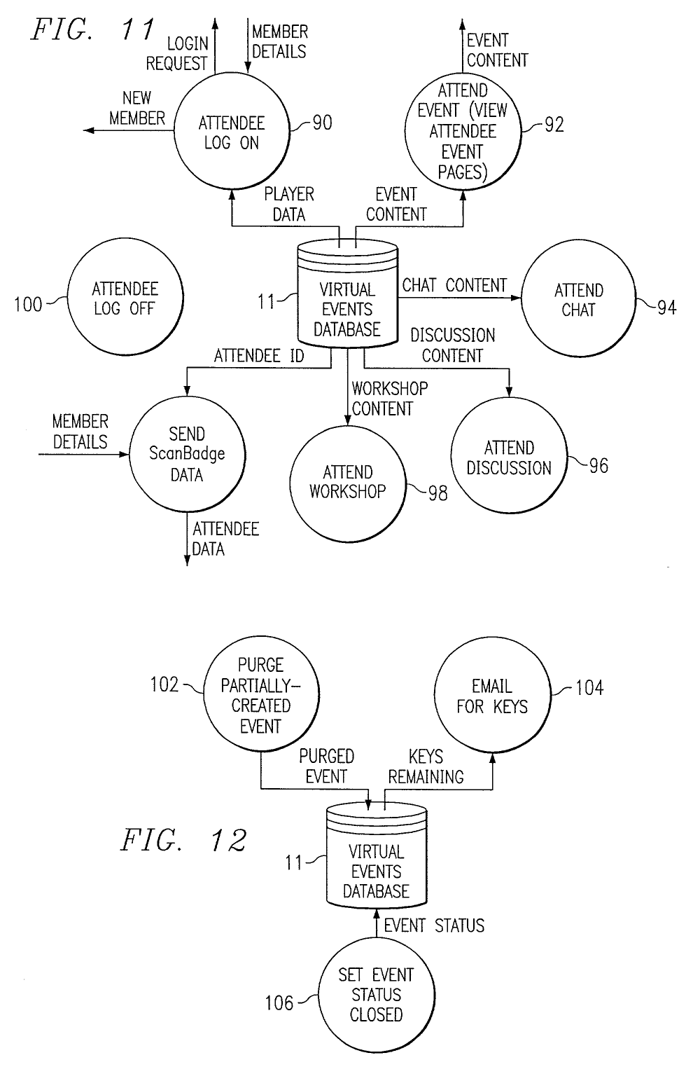

Referring now to FIG. 12, a block diagram depicts use cases associated with event champion module 16 for maintaining database 11 free of excessive data. Purge partially created event use case 102 allows the event champion to remove virtual events from database 11 if a decision is made not to proceed with the virtual event. E-mail for keys use case 104 provides the event champion with notice with unused keys for purged or closed use cases, both to track usage and cost of use of the system. Set event status closed use case 106 allows an event champion to close out a virtual event once the virtual event is complete. A closed out event is generally stored or archived in a separate data facility to allow access by the organization while limiting impact of closed events on database 11.

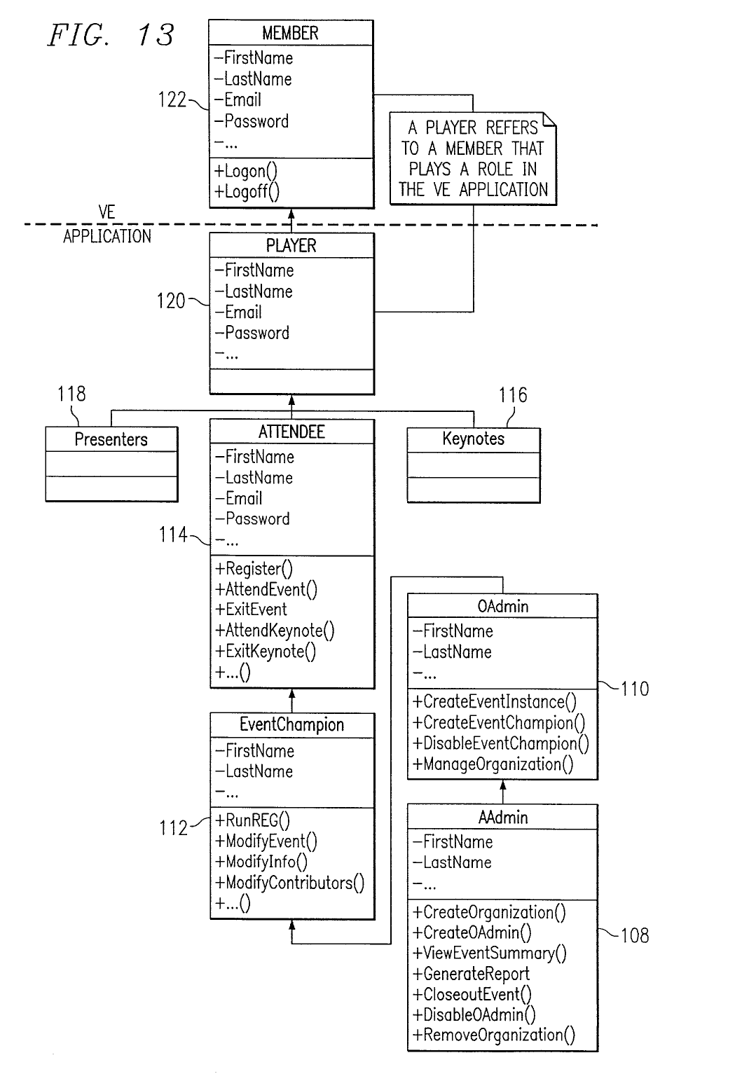

Referring now to FIG. 13, a class diagram model represents inheritance of objects in the virtual event engine with classes that contain examples of attributes and methods. The administrative object 108 identifies the ASP administrator and includes methods to create an organization, create an organization administrator, view event summaries, generate reports, close-out events, disable an organization administrator, and remove organizations. The organization administrator object 110 is created with the create organization administrator method of the administration object 108 and includes the identity of the organization administrator and methods to create events, create event champions, to disable event champions and manage the organizations information. The event champion object 112 is created by the organization administrator object 110 create event champion method. Event champion object 112 identifies the event champion and includes methods to run the rapid event generator, to modify an existing event, to modify information regarding the event, and to modify contributors of the event. One method within event champion object 112 creates an attendee object 114 which is populated as members attend the virtual event. Attendee object 114 identifies the attendee with contact and password information and includes methods to register, attend the event, exit the event, attend a keynote speech and exit a keynote speech. A keynote object 116 and presenters object 118 are associated with attendees who provide keynote addresses or presentations for the virtual event including content for the keynote speech or presentation. A player object 120 is created for a member object 122 when that member plays a role in a virtual event application. Both the player object 120 and member object 122 include information to identify the member. Member object 122 includes a log-on method and log-off method which are used to activate player object 120.

Although the present invention has been described in detail, it should be understood that various changes, substitutions and alterations can be made hereto without departing from the spirit and scope of the invention as defined by the appending claims.

What is claimed is:

1. A system for presenting a virtual event through a network interfaced with the Internet, the system comprising:
an ASP administration module having authority to grant plural organizations access to the network;
an organization administration module associated with each organization, the organization administration module having authority to create plural virtual events;
an event champion module associated with each virtual event and operable to establish a virtual event architecture that accepts content for the virtual event from contributors; and
a contributor module interfaced with the network and operable to upload content from plural predetermined contributors to a virtual event based upon authority granted to the contributor from the event champion module.

2. The system of claim 1 further comprising an attendee module associated with each virtual event, the attendee module operable to authorize attendees to view virtual event content.

3. The system of claim 2 further comprising a member system module operable to establish membership for users to interface with the network.

4. The system of claim 3 wherein the attendee module interfaces users with the member system module if the users are not members of the network.

5. The system of claim 1 further comprising a rapid event generator associated with the event champion module, the rapid event generator operable to present an event champion with one or more templates that define the architecture of a virtual event.

6. The system of claim 5 wherein the rapid event generator defines the number of attendees, the type of content and the duration of the virtual event.

7. A method for presenting virtual events through a network interfaced with the Internet, the method comprising:
authorizing plural organizations access to the network;
each organization authorizing the creation of one or more virtual events through the network, each virtual event having an associated event champion;
establishing a virtual event architecture for each virtual event by the associated event champion, the virtual event architecture identifying one or content contributors; and
uploading content by the content contributors from the Internet.

8. The method of claim 7 further comprising:
defining a predetermined time period for presentation of the virtual event through the Internet; and
authorizing predetermined attendees to access the virtual event during the predetermined time period.

9. The method of claim 8 further comprising:
establishing membership to the network for an attendee before authorizing access by that attendee to the virtual event.

10. The method of claim 7 wherein establishing a virtual event architecture further comprises identifying one or more sponsors of the virtual event.

11. The method of claim 7 wherein establishing a virtual event architecture further comprises identifying one or more exhibitors of the virtual event.

12. The method of claim 7 further comprising:
previewing by the event champion of content loaded to the virtual event; and
authorizing the previewed content by the event champion for presentation in the virtual event.

13. The method of claim 12 wherein the content comprises a video presentation.

14. A system for presenting a virtual event through a network interfaced with the Internet, the system comprising:
a rapid event generator accessible by an event champion and operable to define an architecture of the virtual event based on authorizations of a network administrator for an organization to access the network and an organization administrator associated with the authorized organization for the event champion to create the virtual event.

15. The system of claim 14 further comprising:
a content contributor module associated with the network and operable to upload predetermined content authorized by the event champion.

16. The system of claim 14 wherein the organization administrator authorizes a virtual event by creating an event instance.

17. The system of claim 16 wherein the rapid event generator comprises an object operable to accept the event instance created by the organization administrator and further operable to generate a virtual event object from the event instance and data provided by the event champion.
